(19) United States
(12) Patent Application Publication
(10) Pub. No.: US 2013/0298746 A1
(43) Pub. Date: Nov. 14, 2013

(54) Convertible fret board

(71) Applicant: Harry E. Wood, Madisonville, LA (US)

(72) Inventor: Harry E. Wood, Madisonville, LA (US)

(21) Appl. No.: 13/506,696

(22) Filed: May 11, 2012

(51) Int. Cl. G10D 1/08

(52) U.S. Cl. 84/314 R

(57) ABSTRACT

The convertible fret board is an independent fret board that can be inserted or removed from between the strings and permanent fret board of a slide style arranged string instrument. When installed, it raises the frets near to the strings, thus allowing finger style mote selection. When removed, slide style note selection is played.

### DETAILED DESCRIPTION OF INVENTION

As stated in the background on a slide style string instrument such as a resonator guitar, the strings are far from the frets and can only be played with a slide for note selection. On a regular style string instrument such as a standard guitar, the strings are very close to the frets for fingering the notes. At present, one needs a separate guitar for each style of playing. This invention claimed here solves this problem.

The independent convertible fret board is designed to slide under the high strings of a slide string instrument thus bringing frets close to the strings to allow for finger style playing. It can be removed to return to slide style playing. Nothing like this invention presently exists.

### BRIEF DESCRIPTION OF DRAWING

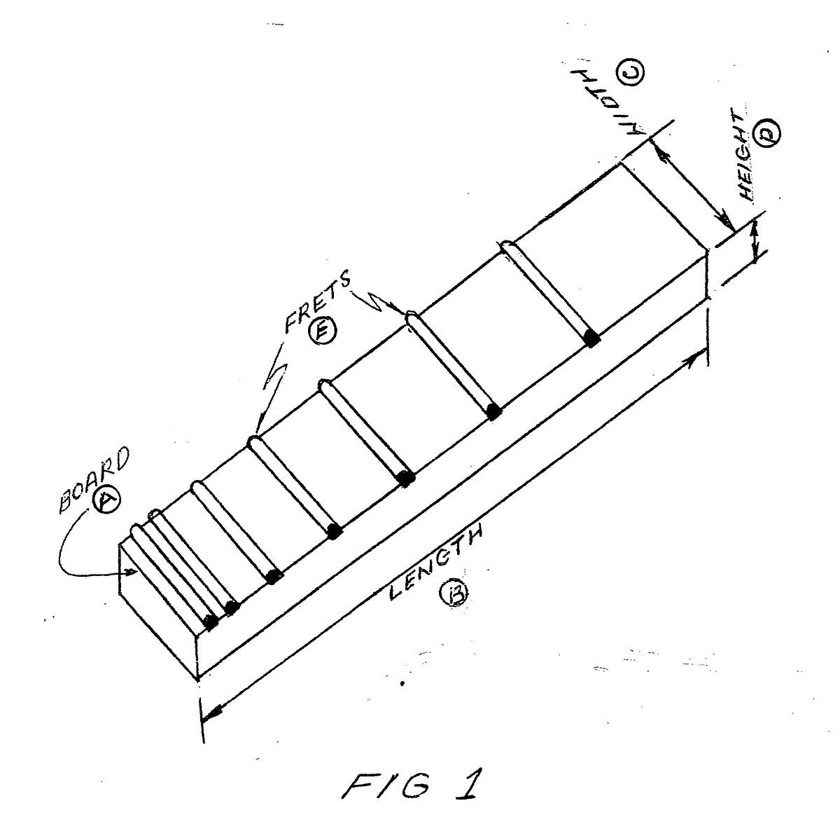

A board FIG. 1(A) is cut to the length FIG. 1(B) and width FIG. 1(C) of the existing instrument's fret board. The height FIG. 1(D) of the board is determined as to have the frets FIG. 1(E) close to the strings when the convertible fret board is inserted under the existing strings. The frets FIG. 1(E) installed on the convertible fret board are at the same spacing as on the existing instrument. They can also be spaced in a chromatic scale or in a diatonic scale for playing in different keys.

What is claimed:

1. An independent fret board to be used with musical string instruments.
